(19) United States
(12) Patent Application Publication
(10) Pub. No.: US 2025/0101913 A1
(43) Pub. Date: Mar. 27, 2025

(54) A POWER GENERATION SYSTEM INCLUDING A GAS TURBINE WITH HEAT RECOVERY STEAM GENERATOR AND CARBON DIOXIDE CAPTURE, AND METHOD

(71) Applicant: NUOVO PIGNONE TECNOLOGIE - S.R.L., Florence (IT)

(72) Inventors: Gianluca ALBERATI, Florence, Firenze (IT); Simone AMIDEI, Florence, Firenze (IT); Damiamo GUADAGNOLI, Florence, Firenze (IT)

(21) Appl. No.: 18/730,949

(22) PCT Filed: Jan. 20, 2023
(86) PCT No.: PCT/EP2023/025027

§ 371 Date: Jul. 22, 2024

(30) Foreign Application Priority Data
Jan. 27, 2022 (IT) 102022000001352

(51) Int. Cl. F02C 6/18; F01K 23/10; F02C 3/34

(52) U.S. Cl. CPC F02C 6/18; F01K 23/10; F02C 3/34

(57) ABSTRACT

The gas turbine system comprises a gas turbine engine, a first fuel line adapted to feed fuel to the gas turbine engine, a heat recovery steam generator adapted to receive flue gas exhausted from the gas turbine engine, and a second fuel line adapted to feed fuel to a post-burner of the heat recovery steam generator. A carbon dioxide capture unit is fluidly coupled to a stack of the heat recovery steam generator. A recycling line recycles flue gas from the stack of the heat recovery steam generator to the post-burner in the heat recovery steam generator. A carbon dioxide return line recycles a gaseous stream containing carbon dioxide from the carbon dioxide capture unit towards the gas turbine engine or the post-burner. Disclosed herein is also a power generation method with improved carbon dioxide capture.

### TECHNICAL FIELD

The present disclosure relates to carbon dioxide removal from flue gas of a gas turbine system. Embodiments disclose herein specifically relate to carbon dioxide removal from flue gas of a combined gas turbine cycle with post-combustion.

### BACKGROUND ART

Carbon dioxide represents the largest fraction of greenhouse gases, which are a major cause of climate changes and increase of the environment temperature. Many human activities involve the production of carbon dioxide. Among those, power generation using fossil fuels, including coal, oil and natural gas plays a major role. In recent years, in an attempt to stimulate the research for technical solutions aimed at reducing the discharge of carbon dioxide in the atmosphere, many governments apply a carbon tax for each ton of greenhouse gas emissions. Businesses as well as consumers, who ultimately bear the additional cost arising from the tax, will take steps, such as switching from fossil fuels to renewable energy resources, or adopting new technologies, to reduce greenhouse emissions and thus limit the amount of carbon tax to pay.

Carbon dioxide emissions can be reduced by switching to alternative energy resources or by capturing carbon dioxide from flue gas produced by the combustion of fossil fuels and prevent the discharge thereof in the atmosphere. Several approaches have been developed, aiming at capturing carbon dioxide from the flue gas to reduce the amount of greenhouse gas released in the atmosphere.

When designing large power generation plants, implementing effective measures to improve carbon dioxide capture becomes increasingly important, in addition to the efficiency of the thermal cycle, which converts thermal energy into useful mechanical energy and ultimately into electric energy.

A major problem in carbon dioxide removal from flue gas generated by a combustion process, such as the combustion of fossil fuel in a gas turbine engine, is represented by the low concentration of carbon dioxide in the flue gas and by the low pressure (around ambient pressure) of the flue gas. These factors render the capturing process inefficient and expensive. Carbon dioxide capture only becomes an effective way of reducing carbon dioxide emissions if the saving in terms of carbon tax is higher than the cost of the carbon dioxide capture process, both as capex as well as costs for operating the system.

As a matter of fact, carbon dioxide capture systems are not only expensive to build and space-demanding, but require also a substantial amount of power, to operate.

Gas turbine combined cycles include a top gas turbine cycle (Bryton cycle), and a bottom steam cycle (Hirn or Rankine cycle), which recovers heat from the flue gas of the gas turbine to generate additional power in a steam turbine. Flue gas from the gas turbine is cooled in a heat recovery steam generator (HRSG) to generate superheated steam, which is then expanded in a steam turbine to generate mechanical power. The molar percentage of carbon dioxide in the flue gas discharged at nearly ambient pressure and around 90° C., is around 3-3.5%. Processing such CO₂-lean flue gas in a carbon dioxide capture unit proved to be inefficient and negatively affects the overall efficiency of the plant.

Embodiments of combined cycles and simple gas turbine cycles including a waste heat recovery boiler and a carbon dioxide recovery unit are disclosed in in EP3756752. In these known embodiments, a flue gas stream from a gas turbine power generation facility is split into a first flue gas stream and a second flue gas stream. The first flue gas stream flows through a first waste heat recovery boiler and the second flue gas stream bypasses the first waste heat recovery boiler. A fraction of the first flue gas stream can be released in the environment through a stack. The remaining first flue gas stream and the second flue gas stream are joined together and fed through a further waste heat recovery boiler which is combined with a nitrogen oxide removal unit for selective catalytic removal. A reduction agent is fed into the nitrogen oxide removal unit for catalytic reaction with the nitrogen oxides. The temperature of the flue gas streaming through the nitrogen oxide removal unit is adjusted by modulating the flowrate of the first and second flue gas streams and the amount of flue gas released in the environment downstream of the first waste heat recovery boiler, such that the most appropriate temperature is achieved in the nitrogen oxide removal unit. Once nitrogen oxides have been removed from the flue gas flowing through the nitrogen oxide removal unit, the flue gas is processed in a carbon dioxide capturing unit. Carbon dioxide is removed from the flue gas and carbon dioxide free flue gas is released in the environment. Captured carbon dioxide is compressed and can be further processed for storage or transportation purposes. These known systems do not effectively improve the efficiency of the carbon dioxide capturing facility.

It would therefore be beneficial to provide systems and methods to concentrate the carbon dioxide content in the flue gas and make carbon dioxide capture more efficient.

### SUMMARY

According to an aspect, disclosed herein is a gas turbine system including a gas turbine engine, a first fuel line adapted to feed fuel to the gas turbine engine and a heat recovery steam generator adapted to receive flue gas exhausted from the gas turbine engine. The system further includes a second fuel line adapted to feed fuel to a post-burner of the heat recovery steam generator. A carbon dioxide capture unit is fluidly coupled to a stack of the heat recovery steam generator and adapted to capture carbon dioxide from the flue gas exhausted from the heat recovery steam generator. A recycling line recycles flue gas from the stack of the heat recovery steam generator to the post-burner in the heat recovery steam generator to increase the carbon dioxide concentration in the flue gas streaming through the carbon dioxide capture unit.

To further increase the carbon dioxide concentration in the flue gas processed by the carbon dioxide capture unit, according to embodiments disclosed herein at least one carbon dioxide return line is provided, to recycle a gaseous stream containing carbon dioxide at least partly processed by the carbon dioxide capture unit towards the gas turbine engine, the post-burner or both.

The mechanical power generated by the gas turbine engine can be used as such to drive rotary machinery, such as a compressor or compressor train. In some embodiments, the mechanical power can be fully or partly converted into electric power.

The steam generated by the heat recovery steam generator can be used in any process where hot steam is required, such as in the paper industry, for instance. Thermal power contained in the steam can also be used for air conditioning or heating purposes, such as district heating or the like.

In some embodiments, steam generated by the heat recovery steam generation is used as working fluid in a bottom thermal cycle, such as a Rankine or Hirn cycle, for further mechanical and/or electric power generation.

In advantageous embodiments, the gas turbine system of the present disclosure can be part of a natural gas liquefaction plant. to provide electric, mechanical and thermal energy thereto.

As will be described in more detail below, reference being made to exemplary embodiments of the system according to the present disclosure, the carbon dioxide containing stream can be diverted downstream of the carbon dioxide capture unit, in which case the stream contains a major part of carbon dioxide. In other embodiments, the carbon dioxide containing gaseous stream can consist of or contain flue gas from the heat recovery steam generator, which has been chilled by the carbon dioxide capture unit, for instance in a direct contact cooler of a chilled ammonia process system.

The gaseous flow containing carbon dioxide returned from the carbon dioxide capture unit can be fed to the suction side of the air compressor of the gas turbine engine. This option is particularly beneficial if the recycled carbon dioxide containing gaseous stream contains chilled flue gas discharged by the direct contact cooler of a chilled ammonia process, for instance. In other embodiments, carbon dioxide can be recycled to the fuel skid which feeds the combustor of the gas turbine engine and/or the post-combustor of the heat recovery steam generator.

According to a further aspect, disclosed herein is a method for generating power with a gas turbine system, the method comprising the following steps:
feeding air and fuel to a gas turbine engine and generate mechanical power therewith;
streaming flue gas exhausted from the gas turbine engine through a heat recovery steam generator;
feeding fuel to a post-burner of the heat recovery steam generator;
generating steam in the heat recovery steam generator;
recycling part of the flue gas exhausted from the heat recovery steam generator to the post-burner;
processing the remaining flue gas exhausted from the heat recovery steam generator in a carbon dioxide capture unit and removing carbon dioxide from the flue gas; and
recycling a gaseous stream containing carbon dioxide from the carbon dioxide capture unit towards at least one of said gas turbine engine and said post-burner.

Further embodiments of the system and method of to the present disclosure are outlined below and set forth in the attached claims.

### BRIEF DESCRIPTION OF THE DRAWINGS

Reference is now made briefly to the accompanying drawings, in which:

FIG. 1 illustrates a system including a combined gas turbine cycle with post-combustion and carbon dioxide capture according to an embodiment;

FIG. 2 illustrates a system including a combined gas turbine cycle with post-combustion and carbon dioxide capture according to a further embodiment;

FIG. 3 illustrates a system including a combined gas turbine cycle with post-combustion and carbon dioxide capture according to a further embodiment;

FIG. 4 illustrates a system including a combined gas turbine cycle with post-combustion and carbon dioxide capture according to yet a further embodiment;

FIG. 5 illustrates a schematic of a chilled ammonia process for carbon dioxide capture, which can be used in the system of FIGS. 1 to 4; and

FIG. 6 is a flowchart summarizing a method of the present disclosure.

### DETAILED DESCRIPTION

To improve carbon dioxide capture efficiency in a system including a gas turbine engine and a heat recovery steam generator with a post-combustor, a carbon dioxide containing gaseous stream is diverted from a carbon dioxide capture unit and recycled to the gas turbine engine, to the post-combustor of the heat recovery steam generator, or both. Specifically, the carbon dioxide containing gaseous stream can be diverted from the carbon dioxide discharge of the carbon dioxide capture unit, in which case the recycled stream contains mainly carbon dioxide. Alternatively, or in combination, flue gas exhausting from the heat recovery steam generator is cooled in a section of the carbon dioxide capture unit as a first step of the carbon dioxide capture process. A portion of the chilled flue gas is diverted and recycled to the gas turbine engine and the remaining chilled flue gas is further processed through the carbon dioxide capture unit.

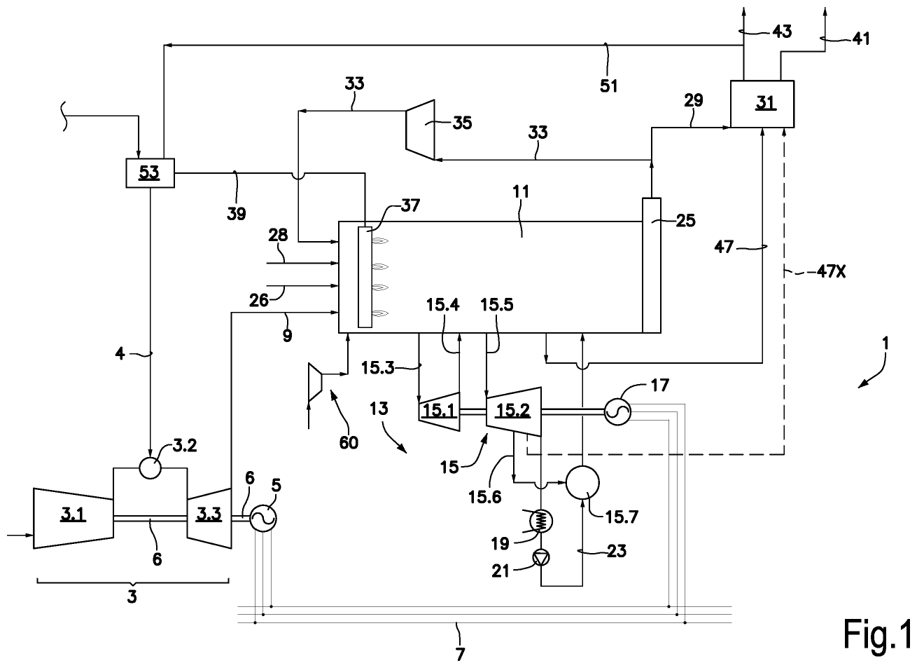

Turning now to the drawings, FIG. 1 illustrates a first embodiment of a power generation system 1 including a gas turbine engine and a carbon dioxide capture unit.

The system 1 comprises a gas turbine engine 3 drivingly coupled to a first electric generator 5. The gas turbine engine 3 can include any kind of gas turbine adapted to drive the electric generator 5. For instance, the gas turbine engine 3 may include a heavy-duty gas turbine, or an aeroderivative gas turbine, for instance a 1-spool, 1.5-spool, 2-spool or 3-spool gas turbine engine.

The gas turbine engine 3 generally includes an air compressor section 3.1, which may include one or more air compressors, for instance a low-pressure air compressor and a high-pressure air compressor. The gas turbine engine 3 further includes a gas turbine combustor 3.2, where to fuel is fed through a fuel line 4, and a turbine section 3.3. The turbine section 3.3 may include one or more turbine wheels. One or more shafts 6 connect the turbine wheel(s) to the air compressor(s) and to the first electric generator 5.

The first electric generator 5 can be electrically connected to an electric power distribution grid 7, which can power the electric devices and machines of the system. In particular, the electric power generated by the first electric generator 5 can be used to power an electric motor which in turn drives a machine, such as a turbomachine, e.g., a compressor or a compressor train.

In other embodiments, the gas turbine engine 3 can be drivingly coupled to a driven machine, for instance to a compressor, or to a compressor train, such that the mechanical power generated by the gas turbine engine 3 is used to drive the driven machine directly, without conversion from mechanical power to electric power.

In some embodiments, the compressor(s) or compressor train(s) directly or indirectly powered by the gas turbine engine 3 can be refrigerant compressors of a natural gas liquefaction system, adapted to liquefy natural gas, or gas compressors for a natural gas pipeline, or the like.

The discharge end of the gas turbine engine 3 is fluidly coupled through a flue gas duct 9 to a heat recovery steam generator 11. As will be described in more detail here below, the heat recovery steam generator removes heat from the flue gas of the gas turbine engine 3 and generates steam therewith. In the embodiment of FIG. 1 the system 1 is a combined gas turbine cycle, where steam generated in the heat recovery steam generator is used in a bottom cycle 13 including a steam turbine 15, which can be drivingly coupled to a second electric generator 17. The steam turbine 15 converts part of the thermal power contained in the hot and pressurized steam, in mechanical power to drive the electric generator 17. This latter can be coupled to the electric power distribution grid 7.

In the embodiment shown in FIG. 1 the steam turbine 15 includes a high-pressure steam turbine section 15.1 and a low-pressure steam turbine section 15.2. In other embodiments, not shown, a different number of steam turbine sections can be foreseen.

Superheated steam can be fed to the inlet of the high-pressure steam turbine section 15.1 through a superheated steam line 15.3. Partly expanded steam from the high-pressure steam turbine section 15.1 can be returned to the heat recovery steam generator 11 through a steam return line 15.4 and superheated once again at a lower pressure before being fed through a second superheated steam line 15.5 to the low-pressure steam turbine section 15.2.

In other embodiments double superheating can be avoided, or more than two superheating can be envisaged.

The bottom cycle 13 further comprises a condenser 19 and a pump 21, which circulates pressurized water back to the heat recovery steam generator 11 along water duct 23.

In the embodiment shown in the drawings the bottom cycle is a Rankine cycle with regeneration. In the exemplary embodiment shown in FIG. 1, a partial flow of partly expanded steam is diverted in a regeneration line 15.6 from the low-pressure steam turbine section 15.2, or from a point upstream thereof, and added (in 15.7) to the cold pressurized water delivered by pump 21 prior to reaching the heat recovery steam generator 11.

In other embodiments, regeneration can be omitted or more than one regeneration step at different temperature and pressure levels can be foreseen.

In other embodiments, not shown, the system 1 can be a co-generative system, which generates mechanical power through the gas turbine engine 3, and heated steam in the heat recovery steam generator 11, the heated steam being used for purposes other than power generation in a steam turbine.

Exhaust flue gas from the heat recovery steam generator 11 is discharged through a stack 25. The exhaust flue gas still contains a residual amount of oxygen, which is at least partly exploited in a post-combustion process in the heat recovery steam generator 11 for the purpose of increasing the carbon dioxide content of the flue gas.

The flue gas stream from stack 25 is split in a main stream, which is fed through a line 29 to a carbon dioxide capture unit 31, and in a recycled stream, which is fed through a recycling line 33, including a blower 35, back to the heat recovery steam generator, and more specifically to a post-burner 37 of the heat recovery steam generator 11. Reference 39 indicates a fuel line feeding fuel to the post-burner 37. The flue gas from the gas turbine engine 3 is mixed with the recycled flue gas stream from recycling line 33 and is mixed with fuel from fuel line 39 to burn the fuel in the post-burner 37.

Post-combustion in post-burner 37 increases the molar percentage (% mol) of carbon dioxide and reduces the residual oxygen content in the flue gas delivered to the carbon dioxide capture unit 31. The additional thermal power generated by post-combustion in the heat recovery steam generator 11 generates an additional amount of steam, i.e., the amount of steam generated by the heat recovery steam generator is increased with respect to the amount of steam generated by a heat recovery steam generator not including a post-burner, due to the higher thermal power made available by the combustion of fuel fed through fuel line 39.

The carbon dioxide capture unit 31 can be based on any suitable carbon dioxide capture technology. In some embodiments, the carbon dioxide capture unit 31 can be based on the so-called chilled ammonia process (CAP), wherein the flue gas is chilled and carbon dioxide is removed therefrom using an ammonia solution. According to other embodiments, the carbon dioxide capture unit 31 may perform a mixed salt process (MSP), or may include a membrane separation facility, for instance, or can be based on any other technically and economically feasible carbon dioxide capture process.

Irrespective of the nature of carbon dioxide separation and abatement process used by the carbon dioxide capture unit 31, the effect of the flue gas treatment in the carbon dioxide capture unit 31 is to remove at least part of the carbon dioxide from the flue gas fed through line 29. Through line 41 a CO₂-lean flue gas, containing a reduced amount of carbon dioxide or no carbon dioxide is released in the atmosphere. Carbon dioxide removed from the flue gas forms a stream almost entirely consisting of carbon dioxide, which is fed through a carbon dioxide discharge duct 43. Carbon dioxide from discharge duct 43 can be stored in suitable CO₂ storage locations, such as for instance abandoned oil and gas fields, deep saline formations or other storage locations adapted for this purpose.

In some embodiments, a fraction of the steam generated by the heat recovery steam generator 11 can be used for the operation of the carbon dioxide capture unit 31, whereto steam can be delivered through a steam line 47 directly from the heat recovery steam generator 11. In addition, or in alternative to the steam line 47, steam can be delivered to the carbon dioxide capture unit 31 also through a line which diverts partly expanded steam from the steam turbine 15, in particular from the low-pressure steam turbine section 15.2, as pictorially represented by line 47X, or from the high-pressure steam turbine section 15.1 (not shown).

Exhaust gas recycling through recycling line 33 and post-combustion in post-burner 37 improve the efficiency of the carbon dioxide capture unit 31, thanks to the higher carbon dioxide concentration in the flue gas processed through the carbon dioxide capture unit 31. The overall efficiency of the system 1 is penalized by the increased amount of fuel needed to run the post-burner, but the improved efficiency of carbon dioxide capturing makes the system economically valuable and ecologically friendly, due to substantial reduction (by around 90%) of greenhouse gas emission.

The molar percentage of carbon dioxide in the flue gas delivered through line 29 to the carbon dioxide capture unit 31 can be increased from 3-3.2% (which is the normal carbon dioxide molar percentage in gas turbine flue gas with no post-combustion or exhaust flue gas recycling in the heat recovery steam generator) to around 8.2-8.5%.

In order to provide better results from the viewpoint of increased molar percentage of carbon dioxide in the flue gas released by the heat recovery steam generator 11, a carbon dioxide diverting line 51 is provided, which connects the carbon dioxide discharge duct 43 to a fuel treatment skid 53, which can provide fuel to the gas turbine combustor 3.2 (fuel line 4) and/or to the post-burner 37 (fuel line 39). Carbon dioxide from the discharge duct 43, pressurized at around 120 bar, is blended with fuel and the fuel/CO₂ mixture is delivered to the gas turbine combustor 3.2, or to the post-burner 37, or both. The amount of carbon dioxide added to the fuel is such as not to adversely affect the combustion process, but increases the total carbon dioxide percentage in the exhaust flue gas at the stack 25 of the heat recovery steam generator 11, thus improving the efficiency of the carbon dioxide capture process performed by the carbon dioxide capture unit 31.

With the system shown in FIG. 1 percentages around 8.7-8.8% (mol) of carbon dioxide can be expected in the exhaust flue gas released by the heat recovery steam generator 11 and delivered to the carbon dioxide capture unit 31. The increased carbon dioxide molar content in the flue gas is beneficial in terms of efficiency of the carbon dioxide capture process performed by the carbon dioxide capture unit 31.

In some embodiments, a supplemental oxidant supply line 60 can feed oxidant (air, pure oxygen or other oxygen-containing gaseous mixtures) to the post-burner 37 as schematically shown in FIG. 1.

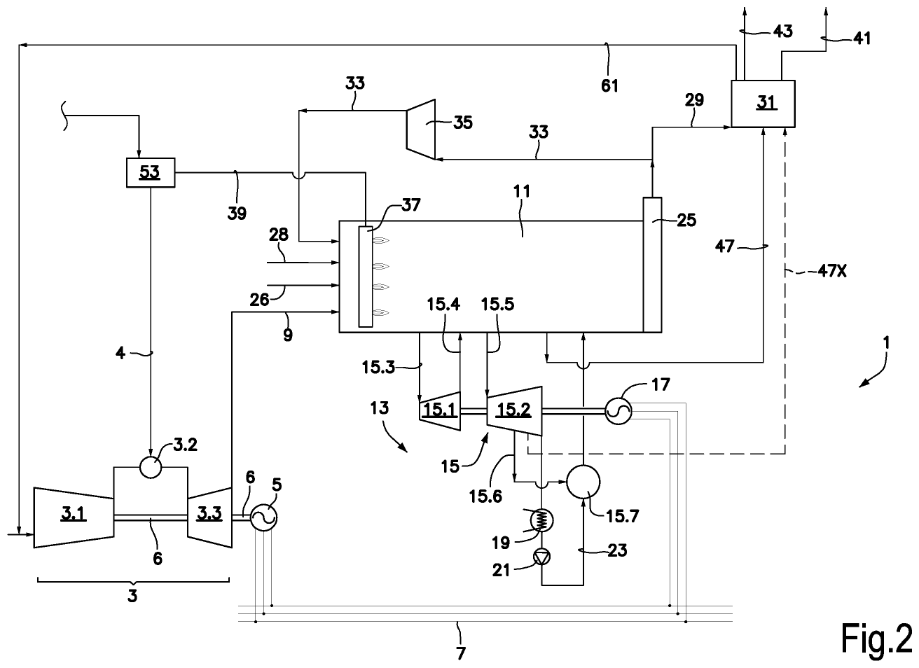

With continuing reference to FIG. 1, a further embodiment of a system according to the present disclosure is illustrated in FIG. 2. The same reference numbers designate the same or equivalent components or parts of the system already shown in FIG. 1 and described above, and which will not be described in detail again.

In the system 1 of FIG. 2 the carbon dioxide diverting line 51 is omitted and the full carbon dioxide stream delivered by the carbon dioxide capture unit 31 is removed through the carbon dioxide discharge duct 43.

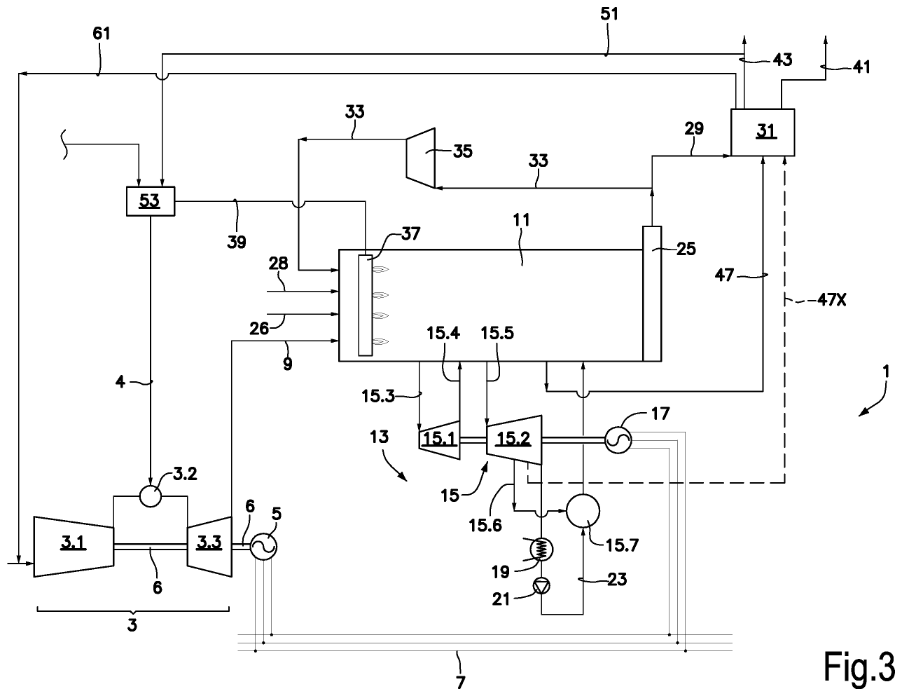

In order to ameliorate the efficiency of carbon dioxide capture in the carbon dioxide capture unit 31, the embodiment of FIG. 3 provides for a flue gas recycling line 61, which connects the carbon dioxide capture unit 31 to the air inlet of the gas turbine engine 3. The inlet of recycling line 61 can be fluidly coupled to a section of the carbon dioxide capture unit 31, where chilled flue gas is present. For instance, the flue gas recycling line 61 may collect flue gas at a temperature ranging from about 5° C. to about 20° C., preferably from about 5°° C. to about 15° C.

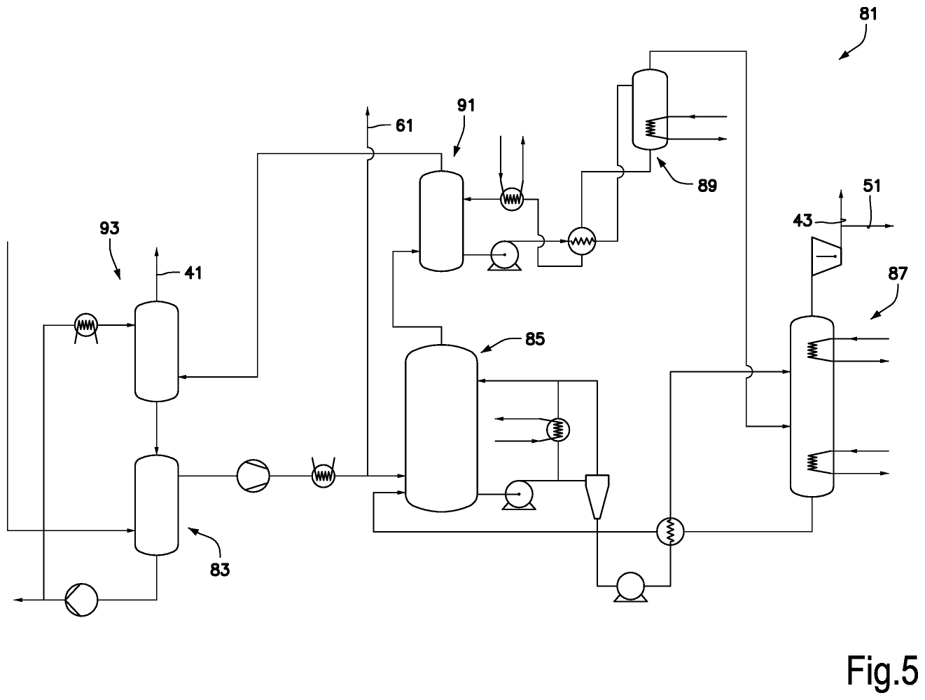

FIG. 5 illustrates a schematic of a known chilled ammonia process plant for carbon dioxide capture. Details on such system are disclosed, e.g., in Ola Augustons et al “Chilled Ammonia Process Scale-up and Lessons Learned”; available at www.sciencedirect.com, a paper presented at the 13th International Conference on Greenhouse Ga Control Technologies, GHGT-13, 14-18, No. 2016, Lausanne, CH. The system, labeled 81 as a whole, comprises a direct contact cooler 83, where the flue gas from the gas turbine is cooled prior to be delivered to a carbon dioxide absorber 85. The system further comprises a regenerator 87, a stripper 89, a water wash station 91 and a direct contact heater 93, where flue gas, wherefrom carbon dioxide removed in the absorber 85, is heated prior to be discharged in the environment. The structure and operation of the system is known and will not be described. Moreover, the schematic of FIG. 5 is provided just as an example of a chilled ammonia process system. Several modifications to the basic layout of the system are known.

In general, a portion of the chilled flue gas exiting the direct contact cooler 83 can be recycled along the chilled flue gas recycling line 61 towards the suction side of the air compressor 3.1 of FIGS. 1-4.

The chilled flue gas recycled through line 61 is fed to the suction side of the air compressor 3.1 of the gas turbine engine 3 and blended with air sucked by the air compressor 3.1.

The effect of recycling chilled flue gas is two-fold. On the one hand, the percentage of carbon dioxide in the stream entering the gas turbine combustor 3.2 is increased, which in turn increases the molar percentage of carbon dioxide and reduces the amount of residual oxygen in the flue gas entering the heat recovery steam generator 11. A reduction of the exhaust flue gas recycling through line 33 and blower 35 can be expected, which in turn reduces the amount of power required for flue gas recycling.

On the other hand, since the temperature of the flue gas recycling through line 61 is usually lower than ambient temperature, an increase in the thermal efficiency of the upper thermodynamic cycle performed by the gas turbine engine 3 is expected.

With continuing reference to FIGS. 1 and 2, FIG. 3 illustrates a further embodiment of the system 1, wherein the improvements of FIGS. 1 and 2 are combined in a single system to provide higher carbon dioxide concentration in the flue gas processed by the carbon dioxide capture unit 31. The same reference numbers used in FIGS. 1 and 2 are used in FIG. 3 to designate the same parts and components of the system, which will not be described again.

In FIG. 3 a chilled flue gas recycling line 61 and a carbon dioxide diverting line 51 are used in combination for increasing the carbon dioxide content in the flue gas processed by the carbon dioxide capture unit 31.

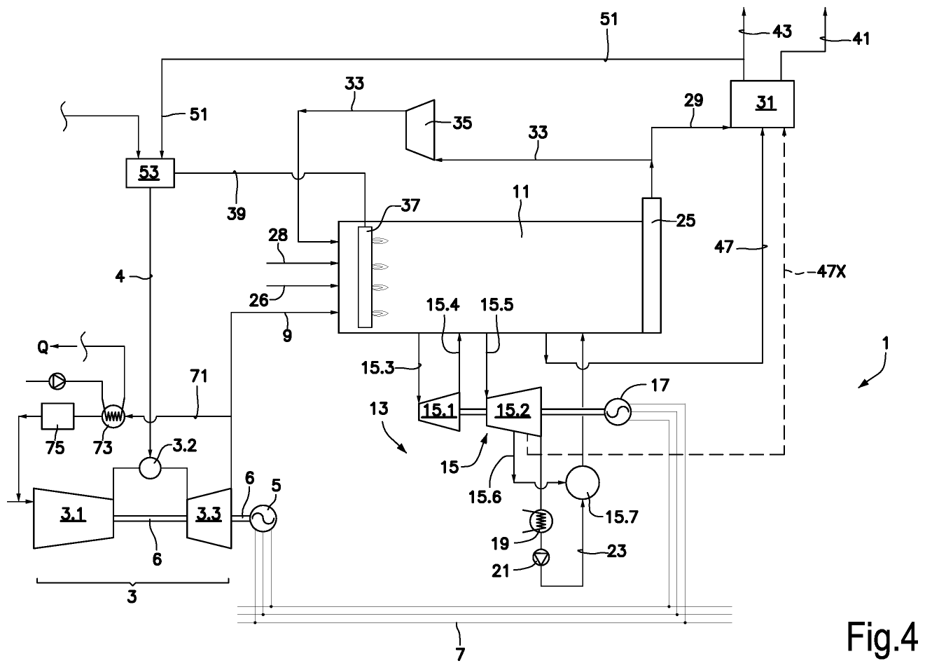

With continuing reference to FIGS. 1, 2 and 3, an alternative embodiment for improving the content of carbon dioxide at the suction side of the air compressor 3.1 of the gas turbine engine 3 is illustrated in FIG. 4. The same reference numbers used in FIGS. 1 and 2 indicate the same or equivalent parts and components already described in connection with FIGS. 1 and 2, which will not be described again in detail.

In the embodiment of FIG. 4, an exhaust flue gas recycling line 71 connects the discharge end of the gas turbine engine 3 to the inlet thereof. A fraction of the flue gas discharged from the turbine section 3.3, which contains a larger percentage of carbon dioxide compared with atmospheric air, due to the combustion process, is thus blended with ambient air to increase the percentage of carbon dioxide in the combustion air delivered to the gas turbine combustor 3.2. This results in higher concentration of carbon dioxide in the flue gas at the stack 25 and ultimately in the flue gas processed through the carbon dioxide capture unit 31.

Before blending with fresh air, the recycled exhaust flue gas in the exhaust flue gas recycling line 71 is cooled in a cooler 73 arranged along the exhaust flue gas recycling line 71. The recycling flue gas in the exhaust flue gas recycling line 71 can be subject to flow treatment, aimed at removing particulates or other contaminants from the exhaust flue gas, which may be detrimental to the operation of the gas turbine engine 3. A generic flow treatment unit 75 is provided for this purpose along the exhaust flue gas recycling line 71, preferably downstream the cooler 73.

Thermal energy (arrow Q) removed from the recycled exhaust flue gas flowing in the exhaust flue gas recycling line 71 can be used in one or more sections of the system 1, or in a separate process or system (not shown). For instance, heat from the cooler 73 can be used to pre-heat fuel fed to the post-burner 37 and/or to the gas turbine combustor 3.2. Thermal energy Q from the cooler 73 can also be exploited in the carbon dioxide capture unit 31 and/or in the bottom cycle 13, for instance to pre-heat water from the condenser 19 before delivery to the heat recovery steam generator 11.

In FIG. 4 the chilled flue gas recycling line 61 (FIGS. 2 and 3) is omitted. However, a combination of the recycling lines 71 and 61 in the same system is not ruled out. Additionally, disclosed herein is also a system 1 including combined recycling lines 61 and 71 but omitting the carbon dioxide diverting line 51.

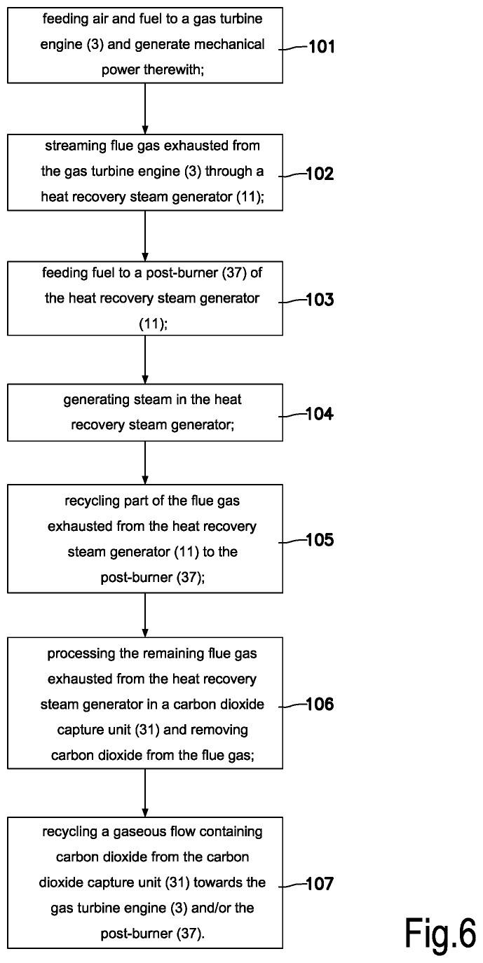

FIG. 6 is a flowchart summarizing a method of the present disclosure. The method illustrated in FIG. 6 includes a step 101 of feeding air and fuel to the gas turbine engine 3 and generate mechanical power therewith. In step 102 flue gas exhausted from the gas turbine engine 3 flows through the heat recovery steam generator 11. In further step 103 fuel is fed to post-burner 37 of the heat recovery steam generator 11 and steam is generated in the heat recovery steam generator (step 104). As described above, flue gas exhausted from the heat recovery steam generator is partly recycled to the post-burner (step 105), while the remaining part of the flue gas is processed in the carbon dioxide capture unit 31 to remove carbon dioxide therefrom (step 106). A gaseous stream containing carbon dioxide from the carbon dioxide capture unit is returned towards the gas turbine engine and/or to the post-burner (step 107).

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

For instance, an additional fuel feed line 26 and an additional oxygen or air feed line 28 can be provided to feed low-quality fuel to the post-combustor and, if needed, additional oxygen. While fuel supplied via the fuel skid 53 to the gas turbine engine can be gaseous fuel, or any other high-quality fuel, the additional fuel feed line 26 can supply a fuel different from the fuel supplied by the fuel skid 53, for instance less noble fuel, such as coal, waste products from other processes, for instances products usually intended to flared, or the like. If required, fuel pre-treatment unit can be provided in the additional fuel feed line, or a combustion gas post-treatment unit can be provided at the discharge of the post-combustor or of the heat recovery steam generator.

1. A gas turbine system comprising:
a gas turbine engine;
a first fuel line adapted to feed fuel to the gas turbine engine;
a heat recovery steam generator adapted to receive flue gas exhausted from the gas turbine engine;
a second fuel line adapted to feed fuel to a post-burner of the heat recovery steam generator;
a carbon dioxide capture unit fluidly coupled to a stack of the heat recovery steam generator and adapted to capture carbon dioxide from the flue gas exhausted from the heat recovery steam generator;
a recycling line, adapted to recycle flue gas from the stack of the heat recovery steam generator to the post-burner in the heat recovery steam generator; and,
at least one carbon dioxide return line adapted to recycle a gaseous stream containing carbon dioxide which has been at least partly processed by the carbon dioxide capture unit towards at least one of said gas turbine engine and said post-burner.

2. The gas turbine system of claim 1, further comprising a bottom thermodynamic cycle including a steam turbine, adapted to expand steam generated by the heat recovery steam generator and produce mechanical power therefrom.

3. The gas turbine system of claim 2, further comprising an electric generator drivingly coupled to the steam turbine.

4. The gas turbine system of claim 1, further comprising an electric generator drivingly coupled to the gas turbine engine.

5. The gas turbine system of claim 1, wherein the carbon dioxide return line comprises:
a carbon dioxide diverting line, fluidly coupled to a carbon dioxide discharge duct of the carbon dioxide capture unit and to a fuel treatment skid fluidly coupled to at least one of the first fuel line and the second fuel line;
wherein, in use, carbon dioxide diverted through the carbon dioxide diverting line is blended in the fuel.

6. The gas turbine system of claim 1, wherein the carbon dioxide return line comprises:
a chilled flue gas recycling line fluidly coupled to the carbon dioxide capture unit and to a suction side of an air compressor of the gas turbine engine;
in use the chilled flue gas recycling line diverting an amount of chilled flue gas from the carbon dioxide capture unit to the air compressor of the gas turbine engine.

7. The gas turbine system of claim 1, further comprising:
a turbine recycling line having an inlet fluidly coupled to a discharge of a turbine section of the gas turbine engine and an outlet fluidly coupled to the suction side of the air compressor of the gas turbine engine;
wherein, in use, an amount of flue gas from the turbine section of the gas turbine engine is recycled to the suction side of the air compressor of the gas turbine engine through the turbine recycling line.

8. The gas turbine system of claim 7, wherein the turbine recycling line includes a cooler.

9. The gas turbine system of claim 7, wherein the turbine recycling line includes a flow treatment unit.

10. A method for generating power with a gas turbine system, the method comprising the following steps:
feeding air and fuel to a gas turbine engine and generate mechanical power therewith;
streaming flue gas exhausted from the gas turbine engine through a heat recovery steam generator;
feeding fuel to a post-burner of the heat recovery steam generator;
generating steam in the heat recovery steam generator; recycling part of the flue gas exhausted from the heat recovery steam generator to the post-burner;
processing the remaining flue gas exhausted from the heat recovery steam generator in a carbon dioxide capture unit and removing carbon dioxide from the flue gas; and,
recycling a gaseous stream containing carbon dioxide from the carbon dioxide capture unit towards at least one of said gas turbine engine and said post-burner.

11. The method of claim 10, further comprising the step of generating mechanical power in a bottom thermodynamic cycle including a steam turbine using the steam generated by the heat recovery steam generator.

12. The method of claim 11, further comprising the step of converting the mechanical power generated by the steam turbine into electric power.

13. The method of claim 10, further comprising the step of converting mechanical power generated by the gas turbine engine into electric power.

14. The method of claim 10, wherein the step of recycling the gaseous stream containing carbon dioxide comprises the step of blending the recycled gaseous stream containing carbon dioxide with fuel fed to at least one of said gas turbine engine and said post-combustor.

15. The method of claim 10, wherein the step of recycling the gaseous stream containing carbon dioxide comprises the step of diverting flue gas chilled in the carbon dioxide capture unit to a suction side of the gas turbine engine.

16. The method of claim 10, further comprising the step of recycling flue gas exhausted from a discharge side of the gas turbine engine to a suction side of the gas turbine engine.
